(19) United States
(12) Patent Application Publication
(10) Pub. No.: US 2026/0287943 A1
(43) Pub. Date: Sep. 24, 2026

(54) PRISM PULSE SHAPER

(71) Applicant: Wisconsin Alumni Research Foundation, Madison, WI (US)

(72) Inventors: Martin T. Zanni, Madison, WI (US); Zachary Faitz, Madison, WI (US); Dasol Im, Madison, WI (US)

(21) Appl. No.: 19/037,575

(22) Filed: Jan. 27, 2025

Related U.S. Application Data
(60) Provisional application No. 63/625,121, filed on Jan. 25, 2024.

(51) Int. Cl. G02F 1/11; G02B 5/30; H01S 3/00

(52) U.S. Cl. CPC G02F 1/11; G02B 5/3066; H01S 3/0057; G02F 2203/26

(57) ABSTRACT

A pulse shaper system for modulating optical pulses is disclosed. The pulse shaper system defines an optical beam path including a first prism pair, a programmable optical frequency filter, and a second prism pair. The prisms can be configured in a 4-prism prism compressor configuration, with the programmable optical frequency filter positioned between the prism pairs. Each of the prisms is a Brewster prism oriented at Brewster's angle relative to the optical beam path. Each of the prisms is composed of a wavelength-matched material.

### CROSS-REFERENCE TO RELATED APPLICATION

This application is related to, claims priority to, and incorporates herein by reference for all purposes U.S. Provisional Patent App. Ser. No. 63/625,121, filed Jan. 25, 2024.

### STATEMENT REGARDING FEDERALLY SPONSORED RESEARCH

This invention was made with government support under 2124983 awarded by the National Science Foundation. The government has certain rights in the invention.

### BACKGROUND

Since their inception, pulse shapers have been a useful tool in the field of ultrafast spectroscopy. They are used to compress pulses, transmit information, and alter the yields of photoproducts, to name only a few applications. Pulse shapers have also become a ubiquitous tool in ultrafast 2D spectroscopy. As first demonstrated by Warren Warren, sequences of pulses with variable time delays and phases can be generated using pulse shapers to collect multidimensional spectra, like 2D IR and 2D Visible spectroscopies or microscopies. In fact, the majority of ultrafast 2D spectroscopy experiments in the pump-probe geometry are now carried out using pulse shapers.

The most common pulse shapers are transverse pulse shapers that operate on the pulse in the frequency domain and consist of two gratings, focusing optics, and a programmable optical frequency filter in a 4-f optical layout. This conventional 4-f design has two significant shortcomings: the grating efficiency and the temporal dispersion created by the pulse shaper itself. There are many options for gratings, but the peak efficiency is typically 70-80% and decreases when moving away from the blazed wavelength, dropping to 60% to 65% for a 100-200 nm pulse. Since two gratings are required, the gratings result in >50% loss in light. Temporal dispersion is caused by transmissive materials within the pulse shaper. Transverse acousto-optic modulators (AOMs) are made from crystals that are about 1 cm thick. The temporal dispersion needs to be removed to create transform limited pulses or to devise a new, well-defined pulse train. The degree to which a pulse can be temporally modulated is set by the frequency resolution of the filter, which depends on the focal spot size at the filter, the number of individual elements the filter can alter, and the pulse's spectral range. A pulse shaper might have up to 700 individually resolvable frequency elements or “pixels”. Whatever AOM bandwidth is utilized to remove the chirp reduces the amount of bandwidth that can be utilized to create the desired shaped pulse. Indeed, some pulse shapers cannot compensate for the dispersion induced internally, and so chirped mirrors are used to pre-compress the pulses prior to entering the pulse shaper.

Pulse shaper repetition rates have also always been limited compared to the repetition rates of pulsed laser systems. For AOMs specifically, the repetition rate is limited (~100 kHz) by the time it takes for the acoustic wave to travel through the material inside the AOM (10 microseconds). In grating-based pulse shapers, sampling the programmed acoustic wave multiple times with a higher repetition rate laser would lead to inaccurate diffraction patterns.

AOM-based pulse shaper repetition rates are currently limited by speed of sound of the acoustic medium in the AOM. Currently, the acoustic wave traveling through the AOM needs to completely pass through the crystal in between two shots from the light source. This limitation means that the time between laser shots can be no less than the speed of sound in the AOM material multiplied by the length of the AOM. The material of AOMs used for frequency domain pulse shaping transmit acoustic waves at approximately 5000 m/s. Additionally, the lengths of these AOMs are approximately 0.05 m. Given these numbers, the time between laser shots needs to be greater than 10 microseconds, which limits laser systems to 100 KHz.

The reason the acoustic wave needs to pass through the AOM before the following laser shot is because the rate of amplitude modulation in the acoustic wave is not constant across the AOM in current pulse shapers. AOM masks need to be written in terms of frequency, but gratings only disperse light linearly with wavelength. When the dispersed wavelengths are mapped to different points across the AOM aperture, they are always nonlinear in terms of frequency. This nonlinearity necessitates an acoustic wave with a changing rate of amplitude modulation so that the time delay between the resulting pulse pair is accurate. If one tried to arbitrarily increase the laser repetition rate above 100 kHz, the light impinging on the AOM aperture would interact with an incorrect mask, leading to inaccuracies in the programmed time delay.

A need exists for pulse shapers with improved efficiency. A need also exists for pulse shapers with an ability to compress pulses without the need for separate compression optics. A need also exists for a pulse shaper to be compatible with laser systems that operate at repetition rate greater than 100 kHz.

### SUMMARY

In an aspect, the present disclosure provides a pulse shaper system for modulating optical pulses in a predefined wavelength range. The pulse shaper system defines an optical beam path. The optical beam path includes a first prism pair, a programmable optical frequency filter, and a second prism pair. The pulse shaper system includes a programmable optical filter controller operably coupled to the programmable optical frequency filter. The first prism pair includes a first dispersing prism and a first collimating prism. The first dispersing prism and the first collimating prism are separated by a first interprism distance. The programmable optical frequency filter is positioned downstream of the first prism pair. The programmable optical frequency filter includes individually programmable pixels. The first collimating prism and the programmable optical frequency filter are separated by a first prism-filter distance. The second prism pair is positioned downstream of the programmable optical frequency filter. The second prism pair includes a second gathering prism and a second collimating prism. The programmable optical frequency filter and the second gathering prism are separated by a second prism-filter distance. The second gathering prism and the second collimating prism separated by a second interprism distance. Each of the first dispersing prism, the first collimating prism, the second gathering prism, and the second collimating prism is a Brewster prism oriented at Brewster's angle relative to the optical beam path. Each of the first dispersing prism, the first collimating prism, the second gathering prism, and the second collimating prism is composed of a wavelength-matched material.

In another aspect, the present disclosure provides a method of modulating optical pulses. The method includes introducing an optical pulse train into a pulse shaper system. The optical pulse train has light with a predefined wavelength range. The pulse shaper system is disclosed herein.

In a further aspect, the present disclosure provides a frequency domain (FD) pulse shaper for modulating optical pulses in a predefined wavelength range. The FD pulse shaper includes a pulse compressor. The pulse compressor includes a dispersing prism pair, a collecting prism pair, and a programmable optical frequency filter. The programmable optical frequency filter is positioned between the dispersing prism pair and the collecting prism pair. The dispersing prism pair and the collecting prism pair are configured as a 4-prism prism compressor.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The disclosure and the following detailed description of certain aspects thereof may be understood by reference to the following figures:

FIG. 1A is a schematic of a pulse shaper system, in accordance with aspects of the present disclosure.

FIG. 1B is a schematic of a pulse shaper system, in accordance with aspects of the present disclosure.

FIG. 2 includes the results of ray tracing simulations to determine optimal lens placement in the prism compressor pulse shaper, in accordance with aspects of the present disclosure. 2(a) depicts the order of optics in the ray tracing simulation. 2(b) depicts the relationship between effective pixel size, mask length, and lens focal length. 2(c) shows the number of effective pixels achievable with each focal length lens.

FIG. 3 is a simulation of AOM bandwidth used by various masks, in accordance with aspects of the present disclosure.

FIG. 4 depicts PG-FROG traces (a-c), their corresponding time marginals (d-f), and the bandwidth used to compress each pulse as well as the bandwidth use to achieve the max double pulse time delay based on the number of pixels (g-i), as described in Example 1.

FIG. 5 is a two-dimensional spectrum of 6/5 carbon nanotubes, as described in Example 1.

FIG. 6 is a visual comparison of nonlinear and linear AOM calibration acoustic waveforms.

### DETAILED DESCRIPTION

Before the present invention is described in further detail, it is to be understood that the invention is not limited to the particular embodiments described. It is also understood that the terminology used herein is for the purpose of describing particular embodiments only and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used herein, the term “downstream” refers to the directionality of the flow of light within a beam path. A second location is downstream of a first location if light arrives at the second location after the first location. It should be appreciated that some optical setups can function in two directions, and in those cases, the terms downstream and upstream can be used interchangeably. As a non-limiting example, a series of high-reflecting mirrors arranged to define a beam path can function in either direction, depending on where the beam is introduced, and the function is not dependent on the direction, so the terms downstream and upstream can be used interchangeable. As a non-limiting example, some optical setups include optics that are directionally-specific, such as beam-splitters, and which do not function the same way in the “forward” and “reverse” directions, so the term downstream is specific to the direction of intended light flow in this instance. As another non-limiting example, some optical setups include optics that may function in reverse, but whose function would destroy the broader purpose of the optical system, such as an optical filter whose purpose is to filter out light from a light source after that light interacts with a sample (in the opposite direction, it would block the light before it reaches the sample), so the term downstream is specific to the direction of intended light flow in this instance. For the avoidance of doubt, the directionality of flow when defining downstream cannot be defined intentionally in a fashion that destroys the function of the optical system.

As used herein, the term “optical beam path” refers to the path which a beam of light takes when introduced into an optical system and the optics that cause the light to take that path, including reflective, transmissive, and diffractive optics. An optical beam path includes mirrors that reflect the beam and transmissive optics that the beam passes through. When describing aspects that are in physical relation to the optical beam path, such as an angle relative to the optical beam path (e.g., Brewster's angle), they are described relative to the beam of light itself, unless the context clearly dictates otherwise. The definition here contemplates that an optic may be considered to be included in the optical beam path by virtue of being an optic that causes the light to take that path, but that optic's orientation may still be defined relative to the beam of light itself (e.g., a Brewster's prism oriented at Brewster's angle describes the orientation relative to the beam of light).

As used herein, the term “optical equivalent” refers to a material that provides the same optical performance as a given material. Two different materials that provide the same optical performance are optical equivalents of one another. In some cases, the optical equivalency can be specific to one particular property (e.g., optical impedance, absorption spectrum, etc.). In some cases, the optical equivalency can be across all properties. In general, the optical equivalence described herein relates to dispersion or focusing properties.

Pulse shapers are phase modulators and/or amplitude filters that modify the electric field of an input laser pulse to create a new pulse or pulses with the desired time-evolving electric field, allowing the user to define the spectral phase, a pulse train, and polarization depending on the configuration. Of course, there are many static optics that alter the spectral and/or time-dependence of a laser pulse. Pulse shapers, on the other hand, are dynamic, permitting computer control over the spectrum and time-dependence of a laser pulse, much like an arbitrary waveform generator for light.

There are many designs of pulse shapers, including ones that utilize acousto-optic programmable dispersive filters (AOPDFs), liquid crystal spatial light modulators (SLMs), micromirrors, and deformable mirrors. The most common are transverse pulse shapers that operate on the pulse in the frequency domain and consist of two gratings, focusing optics, and a programmable optical frequency filter in a 4-f optical layout. The laser pulse impinges on a grating to spatially resolve the frequencies of the pulse. The light is then focused onto the programmable optical frequency filter, such as an acousto-optic modulator (AOM) like used in the Examples below, and then exits in a similar fashion, converting the pulse back into the time-domain. The distance between a grating and a focusing optic as well as the distance between a focusing optic and the filter are equal to the length of the focusing optic, creating a 4f geometry.

By applying a “mask” to the filter that alters the amplitudes and/or phases of the dispersed frequency components, the spectrum can be altered to create the desired temporally shaped pulse. In its simplest implementation, the mask is just the Fourier transform of the desired temporal pulse.

The present disclosure includes an optical design that utilizes a set of prisms so that the programmable optical frequency filter resides inside of a prism compressor. The design improves the efficiency of the pulse shaper and provides the ability to compress pulses without additional compression optics.

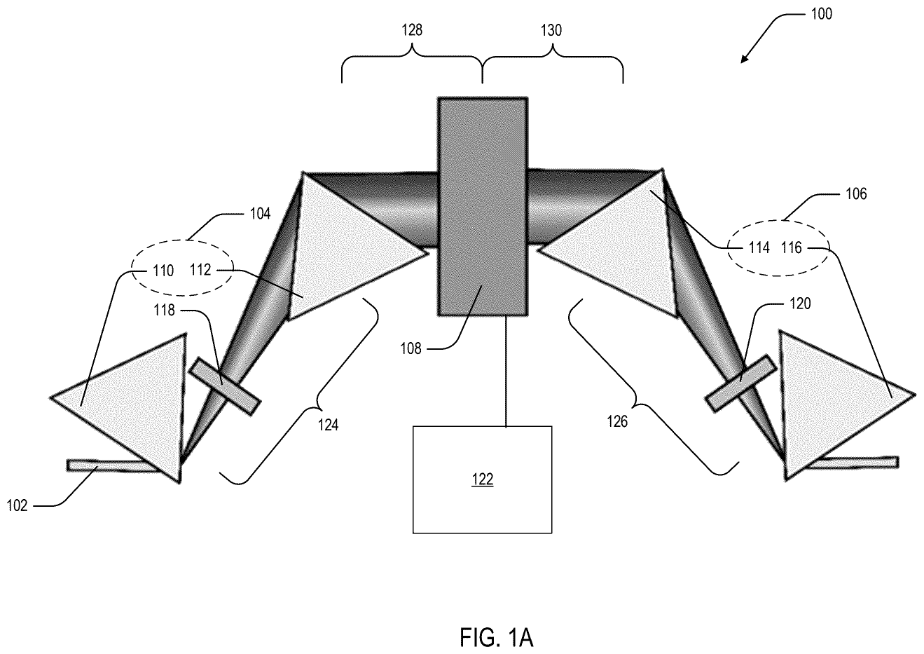

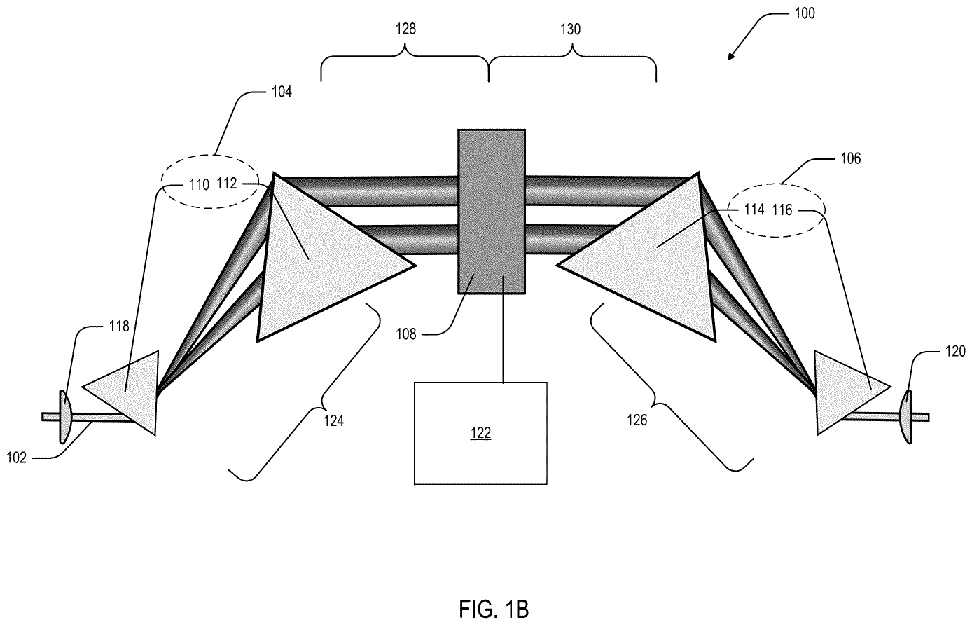

Referring now to FIG. 1A, a pulse shaper system 100 is illustrated. The system 100 defines an optical beam path 102. The optical beam path 102 includes a first prism pair 104, a second prism pair 106, and a programmable optical frequency filter 108. The first prism pair 104 includes a first dispersing prism 110 and a first collimating prism 112. The second prism pair 106 includes a second gathering prism 114 and a second collimating prism 116. The optical beam path 102 can include a first focuser 118 and a second focuser 120. The pulse shaper system 100 includes a programmable optical frequency filter controller 122 operably coupled to the programmable optical frequency filter 108.

We used Synopsys's Light Tools to perform the ray tracing simulations. Each monochromatic simulation was coherent with the input light following a Gaussian intensity profile.

In our new design, the first dispersing prism 110 disperses the light while the first collimating prism 112 collimates the light before it enters the AOM (programmable optical frequency filter 108). To focus the light at the AOM, we use a transmissive lens (first focuser 118) in between the first dispersing prism 110 and the first collimating prism 112. We utilize an acousto-optic modulator for the programmable optical frequency filter, but an SLM or other type of filter might be used instead. After the AOM, the second prism pair 106 and second focuser 120 recombine the light as it exits the pulse shaper.

Brewster's prisms are useful in the present disclosure. They are cut so that both the incident and exiting light encounter the prism-air interface at Brewster's angle. As a result, Brewster's prisms transmit p-polarized light with nearly perfect efficiency across a large range of wavelengths.

The prisms in the pulse shaper are arranged in the form of a 4-prism prism compressor. This design allows us to add a controllable amount of anomalous dispersion to the system, a feature not present in conventional grating-based systems. Transmissive materials in the visible region add normal dispersion, causing shorter wavelengths to lag behind longer wavelengths. Pulse compression optics are intended to counteract this effect, adding anomalous dispersion that allows shorter wavelengths to arrive coincident with longer wavelengths. Prism compressors add anomalous GDD and TOD because longer wavelengths travel through more material than shorter wavelengths. The amount of dispersion depends on the type of prism material, the separation between prism 1 and 2 and prism 3 and 4, the insertion point (the distance from the center of the beam to the tip of the prism), and angle of the prism relative to the incident light. For this pulse shaper, the insertion point should be as close to the tip as possible to avoid adding normal dispersion, and the prism angle is always set to the Brewster angle for efficiency, so we tune the anomalous dispersion by changing the type of prism material and separation.

Still referring to FIG. 1, the first prism pair 104 (e.g., a dispersing prism pair) and the second prism pair 106 (e.g., a collecting prism pair) are configured as a 4-prism prism compressor. In this fashion, the pulse shaper system 100 is the 4-prism prism compressor with the programmable optical frequency filter 108 positioned between the first prism pair 104 and the second prism pair 106.

The pulse shaper system 100 described herein achieves impressive improvements over the current state-of-the-art grating-based pulse shaper systems, as discussed below. These impressive technical achievements are themselves unexpected, but it is also unexpected to achieve the improvements using relatively common optical elements and an optical configuration that is straightforward in appearance. In addition, these improvements have evaded the field for a very long time. For instance, when AOM-based pulse shapers were used to shape mid-IR light in 2006, most of the light was lost due to gratings, leaving the overall efficiency to be around 30%. Gratings, however, are much less efficient in the NIR and visible, leaving overall efficiency around 10%. After 2006, grating-based AOM pulse shaper became commonly used in pump-probe spectrometers across the world, but no improvements were made to efficiency. Replacing the gratings in current pulse shapers with prisms leads to three-fold increase to efficiency since the prisms are approximately 99% efficient.

Pulse shapers have also always struggled to create sub-50 fs pulses without additional compression optics. The first pulse shapers using Treacy grating pairs in 1979 were unable to generate sub-picosecond pulses since the grating configuration itself added dispersion. The inclusion of the 4-f geometry in 1990 removed the dispersion added by the gratings, but left users unable to compensate for the AOM dispersion without additional compression optics. Even in 2019, grating-based pulse shapers are still accompanied by a set of chirped mirror or other compression optics to conduct ultrafast spectroscopy experiments. In the design described here, the dispersive prisms introduce a controllable amount of anomalous dispersion, allowing users to conduct ultrafast spectroscopy experiments without additional pulse compression optics. In addition, the light is dispersed linearly as a function of frequency, not wavelength, which allows theoretically unlimited repetition rate (see below).

The first prism pair 104 receives light from a light source. The first prism pair 104 serves the general purpose of taking a single broadband beam of light where all frequencies are colocalized within a single beam and spatially resolving individual frequencies, such that those distinct frequencies of light can be passed through individual pixels of the programmable optical frequency filter 108. In terms of general function, the function of the first prism pair 104 serves the same general purpose as the grating and parabolic mirror in the conventional grating-based pulse shaper.

The second prism pair 106 effectively outputs the light from the system 100. The second prism pair 106 serves the general purpose of taking broadband light that has been spatially-resolved into distinct frequencies and recombine the frequencies into a single beam of light. In terms of general function, the function of the second prism pair 106 serves the same general purpose as the parabolic mirror and the grating in the conventional grating-based pulse shaper.

The programmable optical frequency filter 108 provides a tunable pulse shape to individual frequencies within the light. The programmable optical frequency filter 108 resides between the first prism pair 104 and the second prism pair 106. The programmable optical frequency filter 108 can be composed of TeO₂, quartz, or germanium, though it is expected that other materials may make suitable programmable optical frequency filters 108. The programmable optical frequency filter 108 can include a maximum of 700 independently programmable pixels. In some cases, the programmable optical frequency filter 108 includes between 50 and 700 independently programmable pixels, including but not limited to, between 250 and 450 independently programmable pixels, which may be a useful number of pixels for a TeO₂ programmable optical frequency filter. In some cases, the programmable optical frequency filter 108 includes between 50 and 500 independently programmable pixels, including but not limited to, between 150 and 350 independently programmable pixels, which may be a useful number of pixels for a quartz programmable optical frequency filter. The quantity of pixels is defined by a ratio of a mask length to a pixel size of the programmable optical frequency filter. The programmable optical frequency filter 108 can be an acousto-optic modulator, a spatial light modulator, or other type of programmable optical frequency filter. Without wishing to be bound by any particular theory, the term “optical frequency filter” is a term of art within the optical arts and does not simply refer to any filter having any impact on optical frequencies.

The programmable optical frequency filter controller 122 can direct the programmable optical frequency filter 108 to apply a mask. A skilled artisan will recognize that a variety of masks can be utilized without deviating from the present disclosure. In some cases, the programmable optical frequency filter controller 122 directs the programmable optical frequency filter 108 to apply a Bragg mask. In some cases, the programmable optical frequency filter controller 122 directs the programmable optical frequency filter 108 to apply a double-pulse mask. In some cases, the programmable optical frequency filter controller 122 directs the programmable optical frequency filter 108 to apply a pulse train mask. In some cases, the programmable optical frequency filter controller 122 directs the programmable optical frequency filter 108 to apply a delay mask. In some cases, the programmable optical frequency filter controller 122 directs the programmable optical frequency filter 108 to apply a pulse compression mask. In some cases, the programmable optical frequency filter controller 122 directs the programmable optical frequency filter 108 to apply an arbitrary mask. In certain aspects, the programmable optical frequency filter controller 122 directs the programmable optical frequency filter 108 to apply a mask selected from the group consisting of a Bragg mask, a double-pulse mask, a pulse train mask, a delay mask, a pulse compression mask, an arbitrary mask, or a combination thereof.

In some cases, the mask can be multiplied by an additional filter function that creates anomalous group velocity dispersion and third-order dispersion. The programmable optical frequency filter controller 122 can optionally apply the additional filter, along with the mask outlined above.

In some cases, the programmable optical frequency filter 108 is an acousto-optic modulator. The acousto-optic modulator can be selected based on a variety of performance factors, including its wavelength-specific pulse shaping performance and intrinsic pixel size. In some cases, the AOM is TeO₂. In general, with TeO₂, the prisms 110, 112, 114, 116 and the AOM have higher efficiency with p-polarized light, so optical rotation should not be necessary for peak efficiency. In these cases, the light should be polarized prior to entry into the system 100 or should be adjusted immediately after entry into the system. In some cases, the AOM is quartz. A skilled artisan will recognize the polarization consequences of selecting certain AOMs. As such, various waveplates may be required to adjust polarization for maximum efficiency. In one specific example, a half waveplate is used to rotate p-polarized light to s-polarized light, which is the preferred polarization for efficiency in quartz, which is passed through the AOM, before another half waveplate is used to rotate the light back to p-polarization. This approach could also be used for other programmable optical frequency filters that require s-polarized light for proper function.

An advantage of using an AOM includes its ability to perform shot-to-shot modulation of the time-evolving electric field at ~100 kHz. This feature enables faster data collection and increased signal-to-noise compared to other programmable optical frequency filters; however, there are other properties of AOM that need to be considered other than their ability to operate at higher repetition rates. Discussed in the paragraph below is information regarding AOM material, diffraction efficiency, and dispersion compensation.

An AOM diffracts light by sending a sound wave through a crystal, introducing transient changes in the refractive index along the crystal that diffract the light. The diffraction efficiency of the AOM depends both on the polarization of light and the AOM mask. For instance, the input light for this pulse shaper needs to be p-polarized to minimize reflections on the Brewster prisms, so we chose to a TeO₂ AOM over other materials because it diffracts p-polarized light. Alternatively, a quartz AOM could be used if two waveplates were also added to rotate the pulse polarization. With regards to the AOM mask, the diffraction efficiency can be described by Eq 1:

$$\frac{I}{{I}_{0}} ∝ s i n {c}^{2} ( \frac{Q}{4} \frac{v}{{v}_{0}} ( 1 - \frac{v}{{v}_{0}} ) ) \qquad ( 1 )$$

where

$$\frac{I}{{I}_{0}}$$

is the ratio of the diffracted light to the diffracted light, Q is a parameter that depends on the thickness and acoustic properties of the crystal, v₀ is the frequency of sound wave that diffracts the light such that the Bragg condition is fulfilled, and v is the frequency of sound wave applied to each wavelength light. The Bragg condition is necessary for efficient diffraction because it fulfills the requirements of conservation of momentum. We can see from this formula that sending a single frequency sound wave through the crystal will only meet the Bragg condition for a single wavelength of light, leading to less efficient diffraction for other wavelengths. For uniform diffraction, we apply a “Bragg mask,” in which the instantaneous frequency of the AOM acoustic wave is changed at each pixel such that each wavelength meets the Bragg condition.

To compensate for dispersion, we multiply the Bragg mask by an additional filter function that creates anomalous GVD and TOD. After dispersion correct, the mask can be further altered to create the desired temporal pulse. Thus, the mask function, M(ω), is given by Eq. 2:

$$M ( ω ) = S ( ω ) * {e}^{- i {{ψ}_{bragg} ( ω )}_{*}} {e}^{- i {ψ}_{M} ( ω )} \qquad ( 2 )$$

where ω is the frequency of light incident on the AOM, S(ω) is the amplitude of the mask, bragg (ω) is the spectral phase necessary to create the Bragg mask, and ψM(ω) is the additional dispersion correction needed to compress the pulse below 50 fsψ_{M}(ω) is typically written in the form of a Taylor series expansion, where different terms correspond to different orders of dispersion (GVD, TOD, etc.).

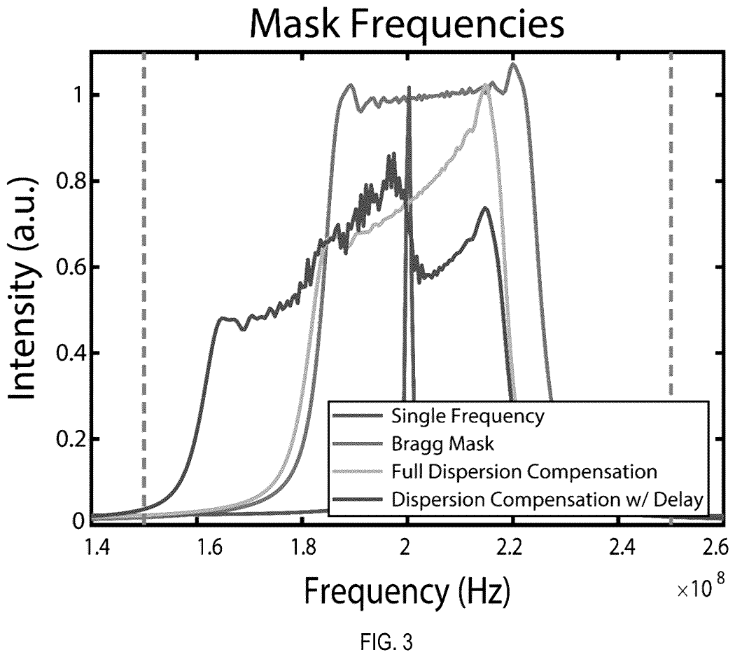

The limit to the complexity of any mask is set by the bandwidth of the AOM (100 MHz centered at 200 MHz for TeO₂). One can estimate the AOM bandwidth used from dispersion compensation alone from the following Eq. 3:

$$Δ {f}_{n} = \frac{1}{2 * p i * {T}_{M}} {\sum }_{i = 2}^{n} \frac{{ψ}_{i} * {( Δ ω )}^{i}}{( i ) !} \qquad ( 3 )$$

where Δfₙ is the AOM bandwidth required for dispersion correction up to the n^{th} order, T_{M} is the mask length in time, ψᵢ represents the i^{th} order of dispersion compensation (GVD, TOD, etc.), and Δω is the bandwidth of light being shaped. Thus, any bandwidth remaining after the Bragg mask and dispersion compensation can be utilized to make a more complex pulse or pulse rain. As an example, we show in FIG. 3 a simulation of the AOM bandwidth used by a single frequency mask, a Bragg mask, a Bragg mask plus the remaining dispersion compensation required after the light travels through the prisms, and a mask after adding the modulations necessary to create a pulse pair with a 600 fs time-delay. We note that deviations away from the Bragg mask reduces the diffraction efficiency according to Eq. 1 and so should be taken into account when programming a desired pulse shape.

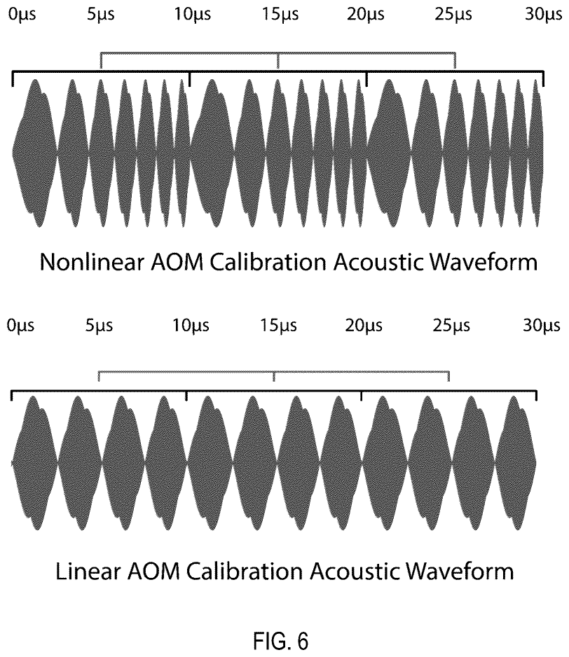

The problem described above with respect to the speed of sound in the acoustic medium of the AOM limiting the pulse repetition rate can only be overcome if the light dispersed across the AOM is linear with frequency rather than wavelength. This removes the nonlinear mapping of wavelength to frequency when programming time delay masks and results in a mask with constant amplitude modulation. In this scenario, one could arbitrarily increase the repetition rate of the laser system and still get correct time delays between shaped pulses. FIG. 6 shows a comparison between non-linear and linear AOM calibration acoustic waveforms.

Brewster prisms with low TOD-to-GDD ratios disperse light linearly with frequency rather than wavelength like gratings, allowing pulse shaping at unlimited repetition rates. The conventional method is to update the AOM shot-to-shot by synchronization to the laser repetition rate. Since the Brewster prisms disperse the light linearly with frequency rather than wavelength, non-synchronized waveforms are now possible, enabling continuous AOM waveforms or slowly varying waveforms. For example, if scanning a time-delay, each laser shot that interacts with the continuous waveform in the AOM will acquire the correct time delay. This method is markedly different from what is capable with grating-based pulse shapers. For example, if one attempted to scan the time delay with a grating-based pulse shaper using a continuous waveform, errors in the programmed pulse delay would be introduced for every laser shot since the light in grating-based apparatuses is dispersed linearly with wavelength rather than frequency. It is important to note that when performing pulse shaping experiments at repetition rates that exceed the conventional AOM limitations, synchronization to the laser source is no longer necessary. Each laser shot is now diffracted from a free-running, continuous, acoustic waveform and can be sorted individually during data processing.

There are, however, other considerations that need to be accounted for when running the pulse shaper at higher repetition rates. Firstly, it is not possible to apply additional dispersion correction to the pulse when running the pulse shaper at high repetition rates. Additional dispersion compensation relies on changing the instantaneous frequency at different part of the mask, meaning the instantaneous frequency will not be constant. Applying additional dispersion correction would introduce a similar problem to dispersing the light linearly with wavelength, causing the impinging light to interact with an incorrect mask at higher repetition rates. The inability to perform dispersion correction also means that one cannot apply a Bragg mask to the pulse, potentially introducing spatial chirp into the pulse shaper system.

In some cases, the system 100 can provide particularly unique performance capability at higher repetition rates, exceeding 200 kHz or even exceeding 1 MHz. In some cases, the repetition rate is at least 200 kHz, at least 300 kHz, at least 500 kHz, at least 750 kHz, at least 1 MHz, at least 5 MHz, or higher. For example, the system 100 can be tailored to operate with input light having a pulse repetition rate of between 200 kHz and 10 MHz. With that being said, the present disclosure is also capable of operating at lower repetition rates. For example, the system 100 can be tailored to operate with input light having a pulse repetition rate of 90 kHz or greater, 95 kHz or greater, or 100 kHz or greater. For example, the system 100 can be tailored to operate with input light having a pulse repetition rate of between 90 kHz and 500 kHz. A skilled artisan will recognize that optical pulse trains have a natural upper limit to their pulse repetition rate that is imposed by the width of the pulse itself. As such, in instances where no upper range is explicitly provided, the upper range is provided by this natural upper limit.

The programmable optical frequency filter controller 122 provides electronic signals to the programmable optical frequency filter 108 to control its performance. Using the equations described herein, the programmable optical frequency filter controller 122 can direct the programmable optical frequency filter 108 to apply a Bragg mask. The system 100 can include various computers and/or processors, as is typical of complex optical systems. The programmable optical frequency filter controller 122 can be fully independent of any computers within the system 100 or can be integrated within one or more of the computers associated with the system 100. A skilled artisan in optics will recognize that the integration of optical and electronic systems can take a wide variety of specific forms and the particular fashion in which the controller 122 is integrated within the broader computing system is not a particular focus of the present disclosure and is not intended to be limiting.

The first collimating prism 112 is downstream of the first dispersing prism 110. The first dispersing prism 110 and the first collimating prism 112 are separated by a first interprism distance 124. The first interprism distance 124 is selected to compensate for the material dispersion introduced by the programmable optical frequency filter.

The second collimating prism 116 is downstream of the second gathering prism 114. The second gathering prism 114 and the second collimating prism 116 are separated by a second interprism distance 126. The second interprism distance 126 is selected to adequately recombine the separated frequencies of light, such that light is recombined from all of the pixels of the programmable optical frequency filter 108. Note that denoting the second gathering prism as “second” is a reference to its inclusion in the second prism pair 106 and not an indication that there must be a first gathering prism.

The programmable optical frequency filter 108 is positioned relative to the first prism pair 104 and the second prism pair 106 to align the pixels of the programmable optical frequency filter 108 with the spatially-resolved light from the prism compressor setup. The programmable optical frequency filter 108 is positioned at a first prism-filter distance 128 from the first collimating prism 112. The programmable optical frequency filter is positioned at a second prism-filter distance 130 from the second gathering prism 114. It should be appreciated that shorter first prism-filter distance 128 and second prism-filter distance 130 afford the use of a shorter focal length lens, which allows a tighter focus and smaller pixels. As mentioned elsewhere, producing a tighter optical focus will only increase the number of pixels until the focal spot size approaches the intrinsic pixel size limit for a given material. In certain cases, the first prism-filter distance 128 can be less than 5 cm, less than 2 cm, less than 1 cm, or a minimally-achievable distance. In certain cases, the second prism-filter distance 130 can be less than 5 cm, less than 2 cm, less than 1 cm, or a minimally-achievable distance. In some cases, the first prism-filter distance 128 must be at least L₂ cos (θ_{B}), where L₂ is the length of side of the first collimating prism 112 and θ_{B} is Brewster's angle of the first collimating prism 112. In certain cases, the second prism-filter distance 130 must be at least L₃ cos (θ_{B}), where L₃ is the length of the side of the second collimating prism 116 and θ_{B} is Brewster's angle of the second collimating prism 116.

The first dispersing prism 110, the first collimating prism 112, the second gathering prism 114, and the second collimating prism 116 are each a Brewster prism. The first dispersing prism 110, the first collimating prism 112, the second gathering prism 114, and the second collimating prism 116 are each oriented at Brewster's angle. The first dispersing prism 110, the first collimating prism 112, the second gathering prism 114, and the second collimating prism 116 are each generally operated with insertion as close to the tip of the prism as possible, though moving the beam slightly away from the tip of the prism does not deviate from the present disclosure.

The first dispersing prism 110, the first collimating prism 112, the second gathering prism 114, and the second collimating prism 116 can each be composed of a wavelength-matched material. The wavelength-matched material can be selected to have a low ratio of third-order dispersion (TOD) to group delay dispersion (GDD) across the wavelength range of interest. The TOD-to-GDD ratio can be calculated with the following formula:

$$\frac{TOD}{GDD} = \frac{λ}{2 π c} * \frac{4 L cos {θ ( \frac{dn}{d λ} )}^{2} - 2 L sin θ ( \frac{{d}^{2} n}{d {λ}^{2}} + ( 2 n - \frac{1}{{n}^{3}} ) {( \frac{dn}{d λ} )}^{2} )}{3 L cos θ ( ( {( \frac{dn}{d λ} )}^{2} + λ \frac{dn}{d λ} ( \frac{{d}^{2} n}{d {λ}^{2}} ) - \frac{3}{2} L sin θ ( \frac{{d}^{2} n}{d {λ}^{2}} + \frac{λ}{3} ( \frac{{d}^{3} n}{d {λ}^{3}} ) ) )} \qquad ( 4 )$$

where λ is the center wavelength of the pulse, c is the speed of light, L is the separation between the prisms, θ is the angle between the shortest wavelength of light and the center wavelength, and n is the refractive index of the prism material. Each of the derivatives are evaluated at the center wavelength. In this work, we consider a low TOD-to-GDD ratio to be less than 2.75.

The prism compressor's material and spacings determine the extent to which the pulse can be compressed. Most materials add more normal GDD than TOD; however, prism compressors add more anomalous TOD than GDD, lengthening the pulse even if one compensates for the system's GDD. To minimize the problem, we chose prism materials with low TOD-to-GDD ratios in the wavelength regions explored: LAK21 for 520-660 nm and SF11 for 840-1180 nm. Next, we set the distance of the prisms such that the anomalous dispersion introduced by the prisms and the Bragg mask equals the normal GDD of the system, which were 150 cm for 520-660 nm and 50 cm for 840-1180 nm. The anomalous TOD from the prisms will be greater than the normal TOD introduced by the transmissive optics in the apparatus, meaning that the remainder of the pulse compression will need to be performed by the AOM.

The first focuser 118 can be positioned between the first dispersing prism 110 and the first collimating prism 112 (i.e., it is downstream of the first dispersing prism 110 and upstream of the first collimating prism 112). The first focuser 118 is positioned at a location that focuses the light into the programmable optical frequency filter 108. By defining the potential locations between the first dispersing prism 110 and the first collimating prism 112 as percentages of the first interprism distance 128, where 0% of the first interprism distance 128 represents a first focuser 118 location that is as near to the first dispersing prism 110 as possible and 100% of the first interprism distance 128 represents a first focuser 118 location that is as near to the first collimating prism 112 as possible. Each of the intervening points is defined by its relative location between the 0% and 100% locations (e.g., halfway is 50%). In some cases, the first focuser 118 is advantageously positioned at a location between 0% and 25% of the first interprism distance 128 so that the light remains focused at the programmable optical frequency filter 108 (e.g., the first focuser 118 is located in the first quarter of the distance between the prisms 110, 112), including but not limited to, between 0% and 20%, between 0% and 15%, between 0% and 10%, or between 0% and 5%. In some cases, the first focuser 118 is advantageously positioned at a location as close as possible to the first dispersing prism 110 (i.e., at 0% of the first interprism distance). Here we define 0% as L₁ cos (θ_{B}), where L₁ is the length of the side of the first dispersive prism 110 and θ_{B} is Brewster's angle for that prism. This quantity is the minimum achievable distance between the tip of the first dispersive prism 110 and the lens such that the focuser remains perpendicular to the beam path. In some cases, the first focuser 118 can be positioned upstream of the first dispersing prism 110.

The first focuser 118 can have focal properties that are tailored to the particular needs of a given application, but in general, the focal properties will be selected to match a focal spot size of the light to a pixel size of the programmable optical frequency filter 108. The focal length of the first focuser 118 will generally be related to the wavelength of the light, in ways that a skill artisan will recognize.

The second focuser 120 can be positioned between the second gathering prism 114 and the second collimating prism 116 (i.e., it is downstream of the second gathering prism 114 and upstream of the second collimating prism). The second focuser 120 is positioned at a location that gathers the light as it diverges from the programmable optical frequency filter 108. By defining the potential locations between the second gathering prism 114 and the second collimating prism 116 as percentages of the second interprism distance 130, where 0% of the second interprism distance 130 represents a second focuser 120 location that is as near to the second gathering prism 114 as possible and 100% of the second interprism distance 130 represent a second focuser 120 location that is as near to the second collimating prism 116 as possible. Each of the intervening points is defined by its relative location between the 0% and 100% locations (e.g., halfway is 50%). In some cases, the second focuser 120 is advantageously positioned at a location between 0% and 25% of the second interprism distance (e.g., the second focuser 120 is located in the first quarter of the distance between the prisms 114, 116), including but not limited to, between 0% and 20%, between 0% and 15%, between 0% and 10%, or between 0% and 5%. In some cases, the second focuser 120 is advantageously positioned at a location as close as possible to the second gathering prism 114 (i.e., at 0% of the second interprism distance 130). In some cases, the second focuser 120 can be positioned downstream of the second collimating prism 116.

In most cases, a light source intended for use with the system 100 will include collimating optics at the light output, which typically collimate the output light. These collimating optics (e.g., a lens or lens system) can be adjusted slightly to fulfill the function of the first focuser 118. In some instances, particularly in cases where the wavelengths are toward the shorter end of the wavelength ranges disclosed, the first focuser 118 can be a collimating optic (e.g., a collimating lens) positioned upstream of the first dispersing prism 110, such that instead of collimating the output light, the output light is gently focused rather than collimated and the light is focused onto the programmable optical frequency filter 108.

For clarity, in some cases, the collimating optics associated with a light source can be used to collimate output light, in which case, a separate first focuser 118 is required to focus the light onto the programmable optical frequency filter 108, and in some cases, the collimating optics associated with the light source can be used to pseudo-collimate the output light with a gentle focus onto the programmable optical frequency filter 108. In either case, it is generally contemplated that some instance of a first focuser 118 is positioned and coordinated with the other optics in system 100 to focus the light onto the programmable optical frequency filter 108.

The first focuser 118 and/or the second focuser 120 can be transmissive and/or reflective.

When the focuser is a transmissive element, the first focuser 118 and/or the second focuser 120 can be composed of a wavelength-matched material, as described elsewhere herein. Such material composition is partly responsible for achieving the pulse compression and shaping performance described herein. Examples of suitable transmissive focusers include, but are not limited to, plano-convex lenses, bi-convex lenses, cylindrical lenses (including complex lens systems), and the like.

When a focuser is a reflective element, the first focuser 118 and/or the second focuser 120 can be composed of reflective focusing optics, such as spherical mirrors, cylindrical mirrors, parabolic mirrors, or the like.

In general, for a desired wavelength range, each optical element should be chosen such that they have high transmission efficiency (or high reflection efficiency) in the desired wavelength range. For the sets of prisms 104 and 106, the materials should be chosen such that the 4-prism prism compressor compensates for the normal GDD introduced by the AOM and other transmissive optics in the pulse shaper system 100. To do this effectively, the ratio of anomalous TOD-to-GDD introduced by the prisms should be under 2.75 so that the AOM can compensate for the remaining anomalous TOD. For focusers 118 and 120, if the chosen optics are transmissive, wavelength-matched antireflective coating should be added to maintain high efficiency for pulse shaper system 100. The programmable optical frequency filter 108 should be chosen such that it has high diffraction efficiency in the desired wavelength region. For transmissive filters, a wavelength-matched antireflective coating should be added to maintain high efficiency for pulse shaper system 100.

In general, for a desired wavelength range, the placement for focusers 118 and 120 should be chosen such that they maximize the resolution of pulse shaper system 100. According to ray tracing simulations with respect to embodiments that do not split the beam into two or more portions (i.e., the layout illustrated in FIG. 1A), this is achieved by placing focuser 118 as close to the first dispersive prism 110 while also ensuring the distance between the focuser and the programmable optical frequency filter 108 is equal to the focal length of focuser 118. To preserve the symmetry of pulse shaper system 100 across the programmable optical frequency filter 108, the distance between the second collimating prism 116 and focuser 120 should be equal to the distance between the first dispersive prism 110 and focuser 118.

For the case of wavelengths from 520 nm to 660 nm, the pulse shaper system 100 is configured with materials and an optical arrangement that provides performance tailored for the wavelength. Within this wavelength range, a wavelength-matched material can be LAK21 glass or its optical equivalent (e.g., LAK21 from Schott, S-BSM81 from Ohara, LACL60 from HOYA, J-LAK01 from HIKARI, or the like). A skilled artisan will recognize that industrial glass suppliers have different trade names for glasses with similar properties and a different naming convention is not intended to alter the teaching of the present disclosure. Within this wavelength range, the first interprism distance 124 and/or the second interprism distance 126 can be at least 125 cm, at least 140 cm, or at least 145 cm. Within this wavelength range, the first interprism distance 124 and/or the second interprism distance 126 can be at most 75 cm, at most 60 cm, or at most 55 cm. Within this wavelength range, the first interprism distance 124 and/or the second interprism distance 126 can be 50 cm. Within this wavelength range, the first focuser 118 and/or the second focuser 120 can have a focal length of at least 1250 mm, at least 1400 mm, or at least 1450 mm. Within this wavelength range, the first focuser 118 and/or the second focuser 120 can have a focal length of at most 1750 mm, at most 1600 mm, or at most 1550 mm. Within this wavelength range, the first focuser 118 and/or the second focuser 120 can have a focal length of 1500 mm. Without wishing to be bound by any particular theory or limited to this particular performance achievement, an arrangement following these parameters can achieve 116 pixels at the programmable optical frequency filter 108.

For the case of wavelengths from 840 nm to 1180 nm, including wavelengths from 840 nm to 1030 nm or wavelengths from 970 nm to 1180 nm, the pulse shaper system 100 is configured with materials and an optical arrangement that provides performance tailored for the wavelength. Within this wavelength range, a wavelength-matched material can be SF11 glass or its optical equivalent (e.g., SF11 from Schott, S-TIH11 from Ohara, FD110 from HOYA, J-SF11 from HIKARI, or the like). Within this wavelength range, the first interprism distance 124 and/or the second interprism distance 126 can be at least 35 cm, at least 40 cm, or at least 45 cm. Within this wavelength range, the first interprism distance 124 and/or the second interprism distance 126 can be at most 175 cm, at most 160 cm, or at most 155 cm. Within this wavelength range, the first interprism distance 124 and/or the second interprism distance 126 can be 150 cm. Within this wavelength range, the first focuser 118 and/or the second focuser 120 can have a focal length of at least 250 mm, at least 400 mm, or at least 450 mm. Within this wavelength range, the first focuser 118 and/or the second focuser 120 can have a focal length of at most 750 mm, at most 600 mm, or at most 550 mm. Within this wavelength range, the first focuser 118 and/or the second focuser 120 can have a focal length of 500 mm.

In a wavelength range of 840 nm to 1030 nm, the pulse shaper system 100 is configured with materials and an optical arrangement that provides performance tailored for the wavelength. Within this wavelength range, the wavelength-matched material can be SF11 glass or its optical equivalent. Within this wavelength range, without wishing to be bound by any particular theory or limited to this particular performance achievement, an arrangement following these parameters can achieve 88 pixels at the programmable optical frequency filter 108.

In a wavelength range of 970 to 1180 nm, the pulse shaper system 100 is configured with materials and an optical arrangement that provides performance tailored for the wavelength. Within this wavelength range, the wavelength-matched material can be SF11 glass or its optical equivalent. Within this wavelength range, without wishing to be bound by any particular theory or limited to this particular performance achievement, an arrangement following these parameters can achieve 74 pixels at the programmable optical frequency filter 108.

It should be appreciated that the preceding several paragraphs provides specifics for a few wavelength ranges, but these specifics are not intended to limit the scope of this disclosure to just those specifics. A skilled artisan will recognize principles that are applicable across each of these examples. Without wishing to be bound by any particular theory, it is believed that a skilled artisan would be capable of recognizing that the optical properties of the prism may be suitable so long as two conditions are met: the programmable optical frequency filter can diffract the input light; and the prisms can transmit the input light.

While particular wavelength ranges are described herein with a high degree of particularity, these wavelength ranges are not intended to be limiting and the principles described are applicable to other desired wavelength ranges, so long as two conditions are met. First, the programmable optical frequency filter 108 must be functionally capable of modulating the desired wavelengths. Second, the transmissive optics of the system 100 must be capable of transmitting the desired wavelengths.

The choice of lens position and focal length impacts the frequency resolution of the pulse shaper. The resolution to which the AOM can alter the frequency components within the bandwidth is set by size of the AOM aperture and the spot size of the focused beam at the AOM. The bandwidth multiplied by the length of the AOM mask in time sets an upper limit on the number of independently programmable pixels and corresponds to the intrinsic pixel size of the AOM (~45 microns for a TeO₂ AOM). To design the shaper, we utilized the Light Tools ray tracing software to simulate the spot size and mask length that is utilized for a series of lens focal lengths and positions, from which we calculated the number of pixels.

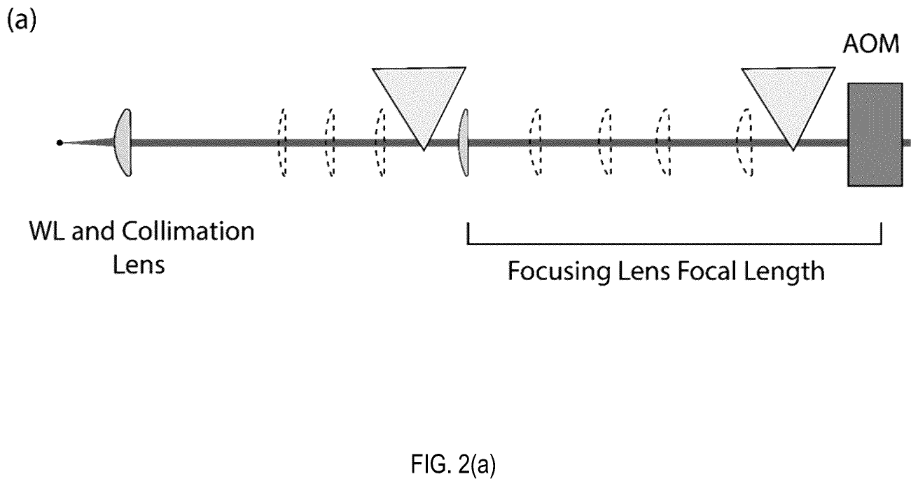

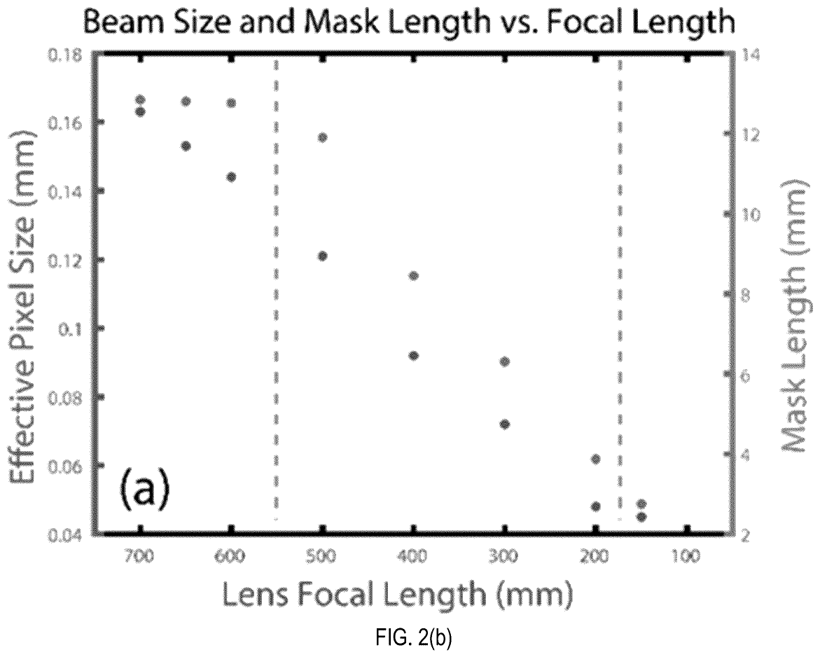

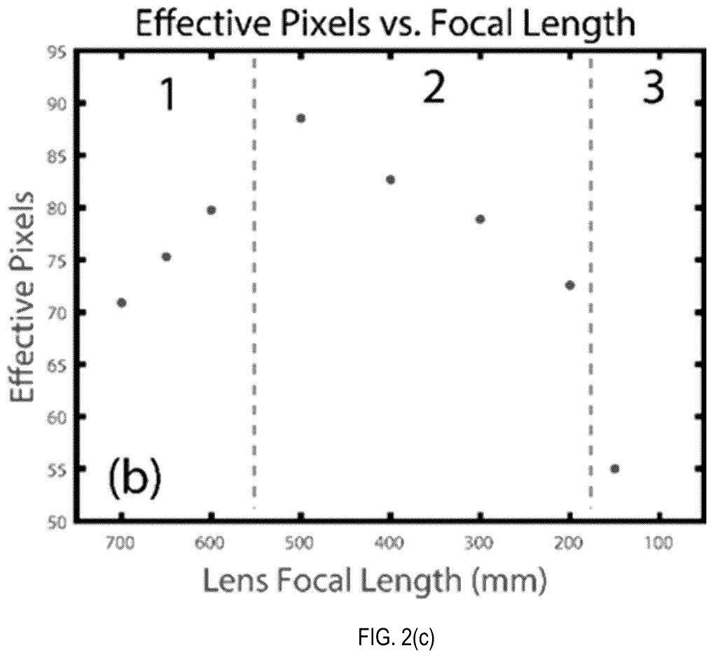

We simulated a total of 8 different lenses with focal lengths ranging from 150 mm to 700 mm with each lens focused at the AOM aperture (FIG. 2(c)). To determine the number of pixels for each lens, we simulated the focused spot sizes of two, 3 mm diameter, monochromatic input beams (840 nm and 1030 nm) that represent the extremes of the bandwidth of our white light. From these simulations, we calculated the FWHMs of the focused beams at the AOM aperture and took the average of the two values as the pixel size (FIG. 2(a), left axis). The lenses also reduce the distance over which the light is spatially dispersed, and so we also calculated the spatial separation between the two colors of light and used this value as the mask length (FIG. 2(a), right axis). By taking the ratio of the mask length to pixel size, we calculate the number of pixels of the pulse shaper (FIG. 2(b)). According to FIG. 2(b), the position with the largest number of pixels corresponds to a lens placed immediately after the first dispersing prism 110 for a shaper built using SF11 prisms and operating between 840-1030 nm. The conclusion also holds for the other two wavelength ranges. We predict that using 500 mm lenses will produce 88 pixels (corresponding to a maximum double pulse delay of 475 fs) for the 840-1030 nm range and 74 pixels (500 fs max double pulse delay) for the 970-1180 nm range. For 520-660 nm light we predict that a 1500 mm lens placed after first dispersing prism 110 resulted in 116 (600 fs max double pulse delay) pixels. We note that the AOM is placed as close as physically possible to the first collimating prism 112 to minimize the focal length and thus provide as small a beam width as possible at the AOM.

We were unable to compress the 520-660 nm pulse with the pulse shaper configuration described above, so for this wavelength range we decreased the material dispersion in the system by removing the focusing lenses and adjusting the position of the white-light collimation optic (FIG. 3) such that the light focused at the AOM aperture. Doing so degraded the shaper frequency resolution (85 pixels and 1.7 nm resolution), but less dispersion compensation enabled sub-50 fs pulse compression and double pulses up to a delay of 460 fs. Removing the lenses did not improve the results for the other two regions of light because it disproportionately impacted the frequency resolution relative to dispersion compensation.

The system 100 can include a light source (not illustrated) that is oriented to introduce pulses of light into the optical beam path 102. Examples of suitable light sources include, but are not limited to, ultrafast lasers, including Ti:sapphire, ytterbium-based, fiber-based and the like.

The beam entering the system 100 can have a beam size of between 1 mm and 5 mm, including between 2 mm and 4 mm, including a beam size of 3 mm. The light source can produce this beam size, or it can be adjusted by optical methods known to those having ordinary skill in the art.

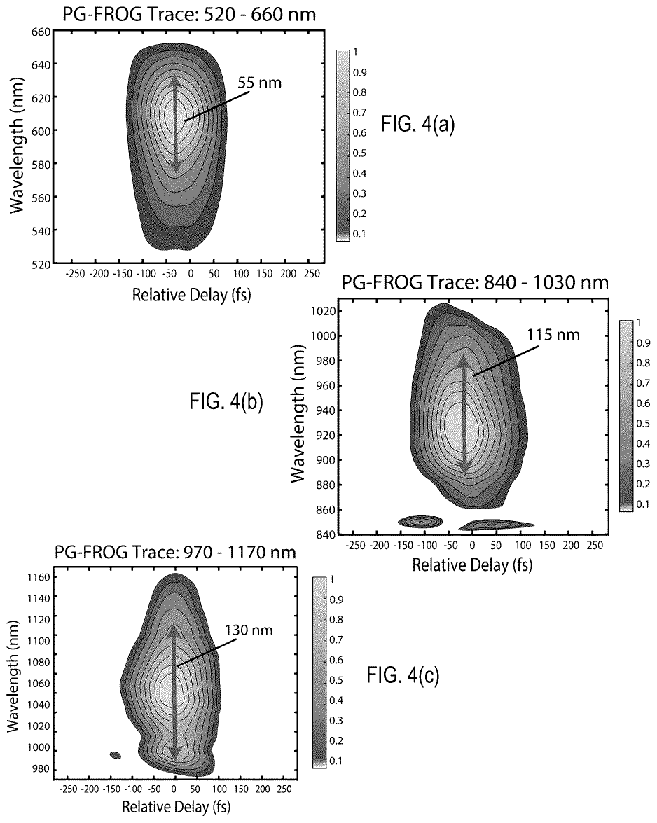

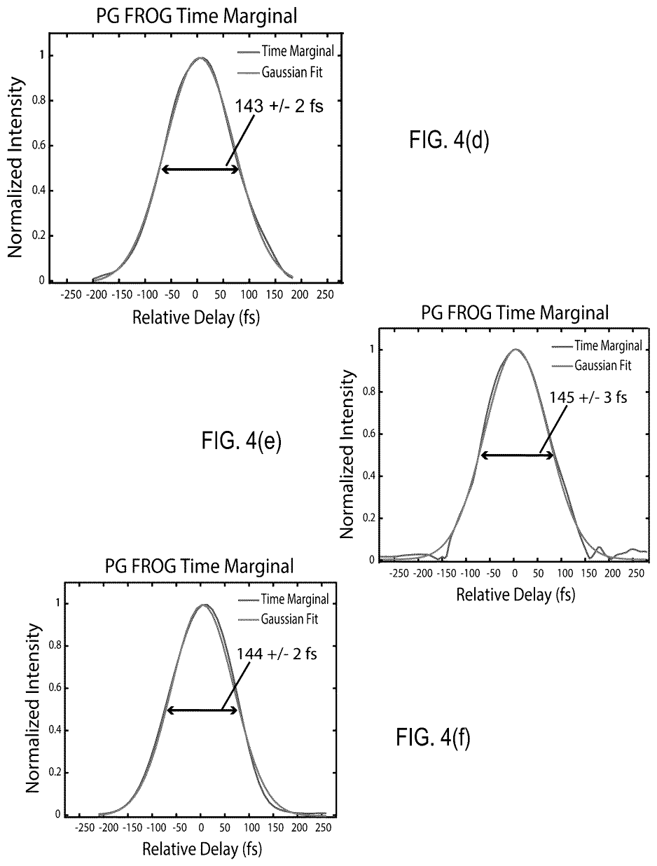

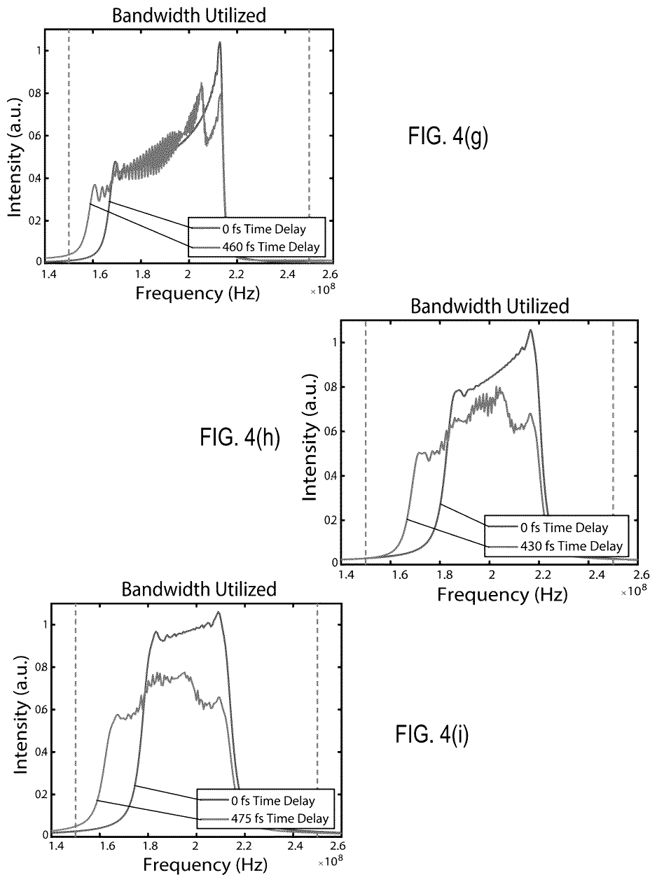

The input beam size is another important parameter since it affects both frequency resolution and the amount of dispersion compensation needed to compress the pulse. Increasing the input beam size leads to tighter focusing at the AOM aperture and a corresponding increase in the number of pixels. A larger beam diameter, however, adds normal dispersion because it increases the insertion point with the first dispersing prism 110 since it impinges further into first dispersing prism 110. One can compensate for the dispersion with the AOM mask, although that reduces the AOM bandwidth available for further shaping the pulse (Eq. 3). To study the effects of beam size, we calculated the effects of beam sizes from 1 to 6 mm diameter on the diffraction efficiency and frequency resolution using the 840-1030 nm light (FIG. 4). The diffraction efficiency decreases with beam size for a mask that maintains a compressed pulse.

We also simulated the bandwidth of the waveform needed to produce the dispersion compensation and max double pulse time delay associated with each input beam size to determine if the bandwidth of the AOM was exceeded. These calculations revealed that for input beam sizes larger than 4 mm, the AOM's bandwidth was exceeded, and that the pulse shaper would be unable to scan out to the max double pulse time delay set by the pixels.

Based on the calculations above, the experimental data presented below were acquired with a pulse shaper built using the following parameters, or the 840-1030 nm and 970-1180 nm wavelengths, we used SF11 prisms separated by 50 cm, 500 mm focal length lens after the first prism, and a 3 mm input beam size. For the 520-660 nm wavelengths, we used LAK21 prisms separated by 150 cm, 1500 mm lenses, and a 3 mm input beam size.

The system 100 can be a sub-system in a broader optical setup, such as a spectrophotometer or a stretcher/compressor for chirped pulse amplification in a laser system. The system 100 can be a standalone unit for dropping into a desired optical arrangement.

The particular optical configurations disclosed herein can be adjusted in ways understood by those having ordinary skill in the optical arts, including adapting the optical geometry without impacting function. In one specific example, the system can be arranged in a reflective mode (e.g., with deformable mirrors as the programmable optical frequency filter 108). In this case, a single prism pair can function as both the first prism pair 104 and the second prism pair 106. In this case, a single prism can function as both the first dispersing prism 110 and the second collimating prism 116. In this case, a single prism can function as both the first collimating prism 112 and the second dispersing prism 114.

Referring to FIG. 1B, a specific implementation of system 100 is illustrated, where at least the first dispersing prism 110 is made from a birefringent material. At least one of the active axes of the birefringent material is aligned with p-polarized light within the system and the other active axis is aligned with s-polarized light. A skilled artisan will recognize that the system remains at Brewster's angle with respect to portions of light that are p-polarized, while the angle may slightly vary for portions of light that are s-polarized. It is contemplated that either the fast or the slow axis of the birefringent material can be aligned with either polarization of light, depending on the requirements of the specific application.

As the system 100 illustrated in FIG. 1B represents a specific implementation of the system 100 illustrated in FIG. 1A and described above, any of the properties of parameters associated with the description of FIG. 1A are applicable to the aspects associated with FIG. 1B. Positioning of the optional first focuser 118 and the optional second focuser 120 may be impacted by the implementation illustrated in FIG. 1B, as the multiple beams emerging from the first dispersing prism 110 may motivate the positioning of the first focuser 118 upstream of the first dispersing prism 110 and/or the positioning of the second focuser 120 downstream of the second collimating prism 116. A skilled artisan will recognize when this situation and others may warrant deviations from a single beam design to a design that is better suited for multiple beams.

In some cases associated with the aspects illustrated in FIG. 1B, the first dispersing prism 110, the first collimating prism 112, the second gathering prism 114, and/or the second dispersing prism 116 are made of a birefringent material.

In certain aspects associated with the illustration in FIG. 1B, the birefringent material can be alpha-barium borate (alpha-BBO), ammonium dihydrogen phosphate (ADP), potassium dihydrogen phosphate (KDP), cesium dihydrogen arsenate (CDA), or the like. In certain aspects associated with the illustration in FIG. 1B, the birefringent material can be transparent in the mid-IR, such as MgBaF₄, LiNbO₃, Gallite, or the like.

In certain aspects associated with the illustration in FIG. 1B, the system 100 can include waveplates before and after the AOM to rotate polarization to align with a preferred polarization of the AOM.

In some cases associated with the aspects illustrated in FIG. 1B, the incident beam can have a polarization that is not purely p-polarized or s-polarized. In some cases, the incident beam can have a polarization that is 45 degrees relative to p-polarized and s-polarized light.

In certain aspects associated with the illustration in FIG. 1B, the system 100 includes two AOMs, one for each polarization that is separated by the first dispersing prism 110. In such cases with two AOMs, an additional first collimating prism 112 and an additional second gathering prism 114 may be included with the additional AOM, while sharing a single first gathering prism 110 and a single second collimating prism 116.

A need exists in the field of ultrafast spectroscopy for phase stable, delayed pulse pairs with full polarization control. Polarization control is a powerful technique that enables one to selectively measure certain pathways or processes in a system by measuring different distributions of transition dipoles. For example, the design of FIG. 1B allows the use of a (0, 90, 45, 45) polarization scheme that removes diagonal peaks from 2D spectra, allowing weaker features such as cross peak to become more prominent. There are similar uses in 2D-SFG spectroscopy, the surface-specific analog to traditional 2D spectroscopy. Polarization control also allows one to perform 2D circular dichroism experiments, which improves the selectivity for certain systems with chiral absorbers.

In addition to the system 100 described herein, the present disclosure provides a method of modulating optical pulses. The method can utilize system 100 and can include any of the features described above with respect to system 100. The method includes: introducing an optical pulse train into the system 100, as described herein. The optical pulse train can have the properties of the light described elsewhere herein.

### EXAMPLES

### Example 1

To construct the prism compressor pulse shaper for wavelengths 840-1180 nm, we used four SF11 Brewster prisms cut for 800 nm from Newlight Photonics (IPS3300-59.0), and two 500 mm focal length, AR coated plano-convex lenses from Thorlabs (LJ1558RM-B). For the prism compressor pulse shaper spanning 520-660 nm, we used two one-inch LAK21 prisms from Edmund Optics (#89-843), two custom two-inch prisms LAK21 prisms from Hangzhou Shalom Electro-Optics, and two 1500 mm focal length, AR coated plano-convex lenses from Thorlabs (LA1254-AB). All experiments we conducted with an AR coated (500 nm-1100 nm) TeO₂ AOM from Phasetech. We also used the Phasetech RFA-VIS amplifier and Quick Control software to control the AOM at a 0.25 duty cycle for the NIR measurements and a 0.75 duty cycle for the visible measurements.

For both near-IR and visible frequency domain measurements, we used the Princeton Instruments Acton SP2150 spectrometer and OMA V InGaAs detector. For the near-IR time domain measurements, we used a Thorlabs biased InGaAs photodiode (DET10A2) and a Zurich Instruments UHFLI 600 MHz with the boxcar integrator option.

To generate NIR white light (850-1040 nm or 980-1160 nm), we used 200 mW of 800 nm light (2.1 μJ/pulse at 95 kHz) from the Light Conversion Pharos 1 with an iOPA-FW-HP focused through a 4 mm YAG crystal. To generate visible white light, we used 300 mW of 1030 nm light (3.1 μJ/pulse at 95 kHz) from the Light Conversion Pharos 1 focused through a 4 mm YAG crystal.

We used PG-FROG to measure the spectral phase of the NIR and visible white light with 150 mW of 800 nm light (1.67 μJ/per pulse at 95 kHz, FWHM=190 fs+/−2 fs) as the gate pulse.

We find the efficiency of the undiffracted, transmitted light through the prism compressor pulse shaper to quantify the losses coming from reflections from lenses, prisms, and the AOM. The transmission efficiency of these optics is approximately 90%, an improvement over the >50% loss seen in grating-based pulse shapers. Since the efficiency is so high with prisms, the overall efficiency is largely set by the AOM (or other type of programmable optical frequency filter). For a TeO₂ AOM, we find the overall efficiency of the pulse shaper to be 32% in the NIR and 35% in the visible by taking the ratio of the diffracted output light power to the input light power. A pulse shaper using a TeO₂ AOM and gratings typically has a 10% efficiency. Thus, replacing the gratings with prisms triples the efficiency, which is valuable when using low intensities pulses such as those generated with white-light continuum. We also note that most grating pulse shapers would already require chirped mirrors, which are not necessary with the prism pulse shaper at these wavelengths and so gives an additional enhancement of roughly 10 to 20% depending on the number of bounce pairs.

To experimentally quantify resolution, we measured the FWHM of the narrowest linewidths we could create with an AOM mask. By placing the lens close to the first prism while remaining focused at the AOM, we find the pulse shaper has approximately 80 pixels (corresponding to 2.5 nm resolution, 430 fs max double pulse delay) with 840-1030 nm light 70 pixels (3 nm resolution, 475 fs max double pulse delay) with 970-1180 nm light, and 108 pixels (1.3 nm resolution, 570 fs max double pulse delay) with 520-660 nm light, which closely correspond to the simulations reported above. For light spanning 520-660 nm, we found that we could achieve 108 pixels (1.3 nm resolution, 500 fs max double pulse delay). We also found that we could achieve 85 pixels (1.7 nm resolution, 460 fs max double pulse delay) after removing the lenses and using the white-light collimation optic to focus the light at the programmable optical frequency filter 108. By removing the lenses, the amount of material dispersion in the system is reduced, allowing one to compress the pulse with less AOM dispersion compensation.

We measured the pulse compression of the shaped light from 840-1030 nm, 970-1170 nm, and 520-660 nm using PG-FROG as shown in FIG. 4. If one attempted to shape the full 330 nm bandwidth of the WL, the AOM's bandwidth would be exceeded simply by producing a Bragg mask, severely limiting the max double-pulse time delay.

Referring to FIG. 4, the arrows on each of the FROG traces correspond FWHMs of the traces along the wavelength axis and represent the bandwidth of the compressed light. The time marginals represent the 3^{rd} order autocorrelation of the gate pulse with the WL and are used to determine the true duration shaped pulse. To obtain the FROG traces shown, the following dispersion compensation was applied using the AOM mask: 7500 TOD for 520-660 nm, 5000 TOD for 840-1030 nm, and 2000 TOD for 970-1180 nm. The bandwidths depicted in FIG. 4 are from masks with the dispersion correction used to compress the pulses with a 0 fs double pulse time delay and a max double pulse time delay (460 fs, 450 fs, and 475 fs for 520-660 nm, 840-1030 nm, and 970-1180 nm, respectively).

We chose PG-FROG because other pulse characterization techniques rely on autocorrelation, which is not possible with our current WL pulse energy (~500 pJ). Techniques like autocorrelations or SHG-FROG require splitting one strong pulse into two pulses with a variable time delay and exploiting non-resonant two-photon processes like second harmonics generation or two photon absorption. PG-FROG, on the other hand, is a cross-correlation technique, allowing us to utilize a strong gate pulse to induce a time dependent birefringence in a X³ medium (Kerr effect). This phenomenon rotates the polarization of WL and allows us to characterize our pulse with low WL pulse energy. When using a cross-correlation technique, however, the extent to which a pulse can be characterized is limited by the length of the gate. We characterized our gate using a 2-photon autocorrelation and measured a FWHM of 190+/−2 fs, where the uncertainty is calculated using the standard error of the mean of the FWHM.

Given our limited temporal resolution with PG-FROG, our goal was to compress our WL pulses to sub 50 fs while remaining as close as possible to the Bragg mask to maintain the benefits of low bandwidth loss (less than 3 db attenuation at a given wavelength based on previous works). We found that the additional dispersion compensation did not cause any wavelength within the regions tested to be attenuated more than 3 db. We found that spatial chirp was exacerbated in the 520-660 nm region. Since the prism separation distance is approximately 3 times longer in this example, a deviation from the Bragg mask causes 3 time more spatial chirp relative to the other regions of light. To determine the bandwidth of our compressed light, we calculated the frequency marginal of the PG-FROG scans integrating over the time axis. From these calculations we find that the shaped light spanning 520-660 nm, 840-10130 nm, and 970-1180 nm have FWHM of 115 nm, 130 nm, and 55 nm, respectively.

To accurately determine the WL pulse duration, we calculate the time marginal of the PG-FROG scan by integrating over the wavelength axis, fitting to a gaussian, and deconvoluting using the gate pulse (FIGS. 4(d)-4(f)). We also used error propagation based on the standard error of the mean of the gate pulse and PG-FROG time marginal to determine the uncertainty of our results. After deconvolution, we find that the pulse durations shaped light spanning 520-660 nm, 840-10130 nm, and 970-1180 nm are 39+/−9, 37+/−6 fs, and 35+/−6 fs, respectively. Since each region of light required a different amount of dispersion correction to compress the pulse below 50 fs, a different amount of the AOM bandwidth was also used. We calculated the AOM bandwidth used for each PG-FROG scan to visualize the remaining bandwidth (FIGS. 4(g)-4(i)). These plots also depict the bandwidth required to achieve the max double pulse delay while maintaining a compressed pulse, and each waveform is within the 100 MHz bandwidth of the AOM.

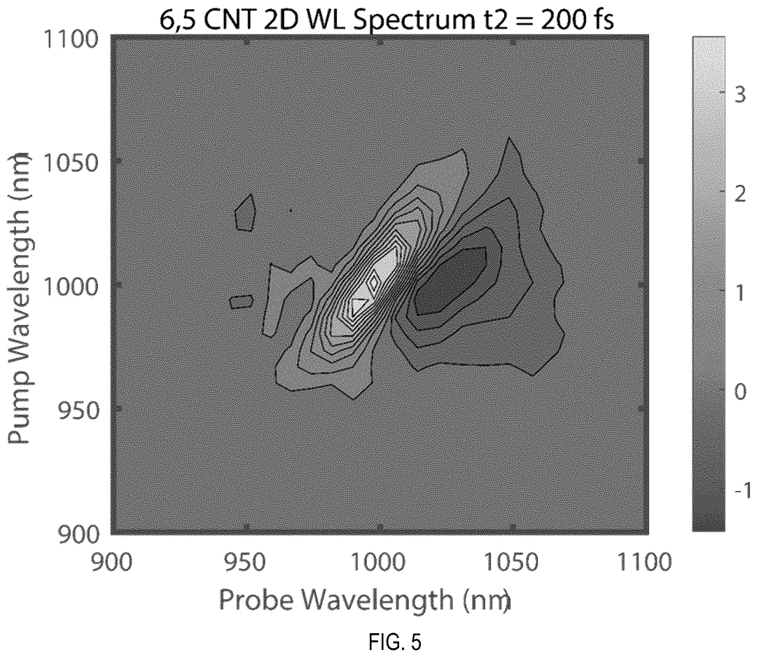

We also demonstrate the pulse shaper's ability to accurately measure multidimensional spectra of a thin film 6,5 carbon nanotubes in FIG. 5. The spectrum was measured at t2=200 fs and exhibits and strong inhomogeneous line shape and a characteristic excited state absorption. Semiconducting carbon nanotubes are strong absorbers with narrow line shapes making them a good standard to test a new apparatus. The spectrum shown in FIG. 5 was measured in the time domain using an InGaAs photodiode with a 4-frame phase cycle where the pulse shaper was used to generate the pump pulse pairs. The ground state bleach appears at 1000 nm, which is expected for 6,5 carbon nanotubes, and there are also excited state absorption peaks which appear at a redder frequency representing the S₁₁ to S₂₂ transition, as expected from prior publications that did not use pulse shaping. The measured homogenous linewidth is ~16 nm which is only 2 nm away from the 14 nm homogenous linewidth measured through photoluminescence. Based on the spectra below, we find that we can measure materials with one of the narrowest solid-state transitions studied with broadband NIR and visible pulses.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed:

1. A pulse shaper system for modulating optical pulses in a predefined wavelength range, the pulse shaper system defining an optical beam path comprising:
a first prism pair comprising a first dispersing prism and a first collimating prism downstream of the first dispersing prism, the first dispersing prism and the first collimating prism separated by a first interprism distance;
a programmable optical frequency filter positioned downstream of the first prism pair, the programmable optical frequency filter comprising independently programmable pixels, the first collimating prism and the programmable optical frequency filter are separated by a first prism-filter distance;
a second prism pair positioned downstream of the programmable optical frequency filter, the second prism pair comprising a second gathering prism and a second collimating prism, the programmable optical frequency filter and the second gathering prism are separated by a second prism-filter distance, the second gathering prism and the second collimating prism separated by a second interprism distance; and
the pulse shaper system further comprising a programmable optical frequency filter controller operably coupled to the programmable optical frequency filter,
wherein each of the first dispersing prism, the first collimating prism, the second gathering prism, and the second collimating prism is a Brewster prism oriented at Brewster's angle relative to the optical beam path, and
wherein each of the first dispersing prism, the first collimating prism, the second gathering prism, and the second collimating prism is composed of a wavelength-matched material.

2. The pulse shaper system of claim 1, wherein the wavelength-matched material has a ratio of third-order dispersion to group delay dispersion of less than 2.75.

3. The pulse shaper system of claim 1, wherein the predefined wavelength range is 520 nm to 660 nm and the wavelength-matched material is LAK21 glass or its optical equivalent.

4. The pulse shaper system of claim 3, wherein the first interprism distance and/or the second interprism distance is between 125 cm and 175 cm or between 140 cm and 160 cm or between 145 cm and 155 cm, optionally wherein the first interprism distance and/or the second interprism distance is 150 cm.

5. The pulse shaper system of claim 1, wherein the predefined wavelength range is 840 nm to 1180 nm and the wavelength-matched material is SF11 glass or its optical equivalent.

6. The pulse shaper system of claim 5, wherein the first interprism distance is between 35 cm and 75 cm or between 40 cm and 60 cm or between 45 cm and 55 cm, optionally wherein the first interprism distance and/or the second interprism distance is 50 cm.

7. The pulse shaper system of claim 1, the optical beam path comprising a first focuser and a second focuser, wherein the first focuser is positioned upstream of the first dispersing prism or between the first dispersing prism and the first collimating prism, and the second focuser is positioned between the second gathering prism and the second collimating prism or downstream of the second collimating prism.

8. The pulse shaper system of claim 1, wherein at least the first dispersing prism is a birefringent prism.

9. The pulse shaper system of claim 1, wherein the pulse shaper system is adapted for an operating pulse repetition rate of 200 kHz or greater.

10. The pulse shaper system of claim 1, wherein the optical beam path is arranged in a reflective mode.

11. The pulse shaper system of claim 10, wherein first prism pair and the second prism pair is a single prism pair.

12. The pulse shaper system of claim 1, wherein the programmable optical frequency filter is an acousto-optic modulator.

13. The pulse shaper system of claim 12, wherein the acousto-optic modulator is TeO₂.

14. The pulse shaper system of claim 12, wherein the independently programmable pixels each have a pixel size that is an intrinsic pixel size of the acousto-optic modulator.

15. The pulse shaper system of claim 1, wherein the programmable optical frequency filter is a spatial light modulator.

16. The pulse shaper system of claim 1, wherein the programmable optical frequency filter controller is further adapted to direct the programmable optical frequency filter to apply a mask selected from the group consisting of a Bragg mask, a double-pulse mask, a pulse train mask, a delay mask, a pulse compression mask, an arbitrary mask, or a combination thereof.

17. The pulse shaper system of claim 1, wherein the first prism-filter distance and/or the second prism-filter distance is less than 5 cm or is a minimal achievable distance.

18. The pulse shaper system of claim 1, further comprising a light source oriented to deliver pulses of light to the optical beam path.

19. A method of modulating optical pulses, the method comprising: introducing an optical pulse train into a pulse shaper system, wherein the optical pulse train has light with a predefined wavelength range, wherein the pulse shaper system defines an optical beam path comprising:
a first prism pair comprising a first dispersing prism and a first collimating prism downstream of the first dispersing prism, the first dispersing prism and the first collimating prism separated by a first interprism distance;
optionally a first focuser optionally positioned between the first dispersing prism and the first collimating prism;
a programmable optical frequency filter positioned downstream of the first prism pair, the programmable optical frequency filter comprising independently programmable pixels, the first collimating prism and the programmable optical frequency filter are separated by a first prism-filter distance;
a second prism pair positioned downstream of the programmable optical frequency filter, the second prism pair comprising a second gathering prism and a second collimating prism, the programmable optical frequency filter and the second gathering prism are separated by a second prism-filter distance, the second gathering prism and the second collimating prism separated by a second interprism distance; and
optionally a second focuser optionally positioned between the second gathering prism and the second collimating prism,
the pulse shaper system further comprising a programmable optical frequency filter controller operably coupled to the programmable optical frequency filter,
wherein each of the first dispersing prism, the first collimating prism, the second gathering prism, and the second collimating prism is a Brewster prism oriented at Brewster's angle relative to the optical beam path, and
wherein each of the first dispersing prism, the first collimating prism, the second gathering prism, and the second collimating prism is composed of a wavelength-matched material.

20. A frequency domain (FD) pulse shaper for modulating optical pulses in a predefined wavelength range, the FD pulse shaper comprising: a pulse compressor comprising a dispersing prism pair, a collecting prism pair, and a programmable optical frequency filter positioned between the dispersing prism pair and the collecting prism pair, wherein the dispersing prism pair and the collecting prism pair are configured as a 4-prism prism compressor.
